(19) United States
(12) Patent Application Publication
(10) Pub. No.: US 2005/0125993 A1
(43) Pub. Date: Jun. 16, 2005

(54) Pick and place machine with improved setup and operation procedure

(76) Inventors: David D. Madsen, Lakeland, MN (US); Paul R. Haugen, Bloomington, MN (US); Timothy G. Badar, St. Paul, MN (US)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/979,750

(22) Filed: Nov. 2, 2004

Related U.S. Application Data
(60) Provisional application No. 60/518,260, filed on Nov. 7, 2003.

(51) Int. Cl. H01F 7/06

(52) U.S. Cl. 29/739; 29/832; 29/834; 29/744; 414/737

(57) ABSTRACT

Embodiments of the present invention improve upon component level inspection performed by pick and place machines. Such improvements include providing first article inspection in pick and place machines by collecting images of the placement event inside the machine and identifying errors as they happen. By displaying this information as it is generated on the machine, the operator can take prompt and effective corrective actions. In one embodiment, images are taken of the placement location before and after placement of the component. These images are then processed and displayed to the operator shortly after the placement has completed. In addition to the images, key measurements are displayed to the operator to assist in the diagnosis of problems as they occur. Key features that are presented to the operator include absence/presence detection, vibration detection and manual visual inspection.

### CROSS-REFERENCE TO RELATED APPLICATIONS

The present application is based on and claims the benefit of U.S. provisional patent application Ser. No. 60/518,260, filed Nov. 7, 2003, the content of which is hereby incorporated by reference in its entirety.

### COPYRIGHT RESERVATION

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Pick and place machines are generally used to manufacture electronic circuit boards. A blank printed circuit board is usually supplied to the pick and place machine, which then picks electronic components from component feeders, and places such components upon the board. The components are held upon the board temporarily by solder paste, or adhesive, until a subsequent step in which the solder paste is melted or the adhesive is fully cured.

Pick and place machine operation is challenging. Since machine speed corresponds with throughput, the faster the pick and place machine runs, the less costly the manufactured board will be. Additionally, placement accuracy is extremely important. Many electrical components, such as chip capacitors and chip resistors are relatively small and must be accurately placed on equally small placement locations. Other components, while larger, have a significant number of leads or conductors that are spaced from one another at a relatively fine pitch. Such components must also be accurately placed to ensure that each lead is placed upon the proper pad. Thus, not only must the machine operate extremely fast, but it must also place components extremely accurately.

In order to enhance the quality of board manufacture, fully or partially populated boards are generally inspected after the placement operation(s), both before and after solder reflow, to identify components that are improperly placed or missing or any of a variety of errors that may occur. Automatic systems that perform such operation(s) are highly useful because they help identify component placement problems prior to solder reflow. This allows substantially easier rework and/or the identification of defective boards after reflow that are candidates for rework. One example of such a system is sold under the trade designation Model KS Flex available from CyberOptics Corporation of Golden Valley, Minn. This system can be used to identify such problems as alignment and rotation errors; missing and flipped components; billboards; tombstones; component defects; incorrect polarity; and wrong components.

Identification of errors pre-reflow provides a number of advantages. Rework is easier; closed-loop manufacturing control is facilitated; and less work in-process exists between error generation and remedy. While such systems provide highly useful inspection, they do consume plant floor-space as well as programming time and maintenance efforts.

One relatively recent attempt to provide the benefits of after-placement inspection located within a pick a place machine itself is disclosed in U.S. Pat. No. 6,317,972 to Asai et al. That reference reports a method for mounting electric components where an image of a mounting location is obtained prior to component placement, and compared with an image of the mounting location after component placement to inspect the placement operation at the component level.

While the disclosure of Asai et al. marks one attempt to employ in-machine component level inspection, there remains much work to be done. For example, the disclosure of Asai et al. teaches acquiring two images, before and after the placement of the component to determine placement characteristics of the component. While this approach is useful for determining the absence or presence of a component after placement, there are several important machine characteristics of the placement machine that can cause placement errors of components that this approach does not address.

One major common cause for placement defects in pick and place machine are errors in the setup and programming. Pick and place operations are inherently complicated, depending on many setup parameters and variables to be adjusted properly to ensure all components are placed correctly on the workpiece. Typical circuit boards can contain hundreds or thousands of components, often with hundreds of different component types. The pick and place machine program contains information about the placement location and orientation of all the components, the type of nozzle required to place each of the components, and information about the board size and location. Additionally, the component feeders must be loaded on the pick and place in positions that reflect the anticipated location of the parts by the placement program. Machine parameters, such as placement speed, vacuum amount, nozzle travel, board support placement and calibration parameters must all be set properly to ensure correct placement of all the components.

When required to program the pick and place machine for a new product, the operator will assemble several workpieces and inspect them to determine if the setup parameters and variables are correctly adjusted. This inspection step is typically referred to as “first article inspection.” After adjustment to the pick and place machine, several more workpieces are assembled and inspected to verify that the causes for failures were corrected. Often, it takes several cycles of adjustment and inspection until the pick and place machine reliably places all components on the workpiece. Since the current state of the art for “first article” board inspection requires expensive automatic optical inspection machines or human inspectors, the inspection does not occur until the board is fully assembled and reflowed. The results of this process are a long delay to setup a circuit board production line for a new product and the generation of expensive scrap in the form of inoperable circuit boards. The amount of time required for first article inspection ranges from 5 minutes to 5 hours depending on the complexity of the verification. Typical duration of the first article inspection process is about 30 minutes. These delays increase the complexity of changing a manufacturing line over to a new product, as well as adding cost to the manufactured boards.

In addition to machine setup, problems during machine operation over time can occur due change and drift of process parameters. Empty feeders, wrong components placed in the feeders, dry solder paste, and wrong board orientations are a few examples of problems that occur during the operation of the pick and place machine. When such problems occur, it is extremely important that such problems be diagnosed and remedied very quickly to return the line to manufacturing viable boards. When a production line is shut down for diagnostics and repair, expensive technician time is required to remedy the problems. Moreover, as the repair is performed, the technician or an operator may have to run the line through yet another setup cycle in order to verify that the problem is fixed, and that boards can be reliably produced.

### SUMMARY OF THE INVENTION

Embodiments of the present invention improve upon component level inspection performed by pick and place machines. Such improvements include providing first article inspection in pick and place machines by collecting images of the placement event inside the machine and identifying errors as they happen. By displaying this information as it is generated on the machine, the operator can take prompt and effective corrective actions.

In one embodiment, images are taken of the placement location before and after placement of the component. These images are then processed and displayed to the operator shortly after the placement has completed. In addition to the images, key measurements are displayed to the operator to assist in the diagnosis of problems as they occur. Key features that are presented to the operator include absence/presence detection, vibration detection and manual visual inspection.

In another embodiment, images and key parameters extracted from the images are collected and stored for later review. Key process parameters can be compared and trend analysis is performed over the assembly of multiple workpieces. A knowledge database is then established to track symptomatic images and corrective actions taken as a result of the displayed symptoms. Further, the images and data collected in the database can be shared with experts located away from the pick and place machine to diagnose and correct problems. One example of such location is the rework stations found at the end of the production line. Another example includes sending the images to the pick and place machine vendor so that the vendor's experts can be enlisted in determining the cause of the problems.

These and other advantages of embodiments of the present invention will be apparent from the description below.

### BRIEF DESCRIPTION OF THE DRAWINGS

FIG. 1 is a diagrammatic view of a Cartesian pick and place machine with which embodiments of the invention can be practiced.

FIG. 2 is a diagrammatic plan view of a turret pick and place machine with which embodiments of the invention can be practiced.

FIG. 3 is simplified diagrammatic view of an image acquisition system aligned with the placement point of a component placement machine.

FIG. 4 is a diagrammatic view of a pick and place machine with an attached image viewer disposed to display images and data of placement operations.

FIG. 5 is a block diagram of the operation of the pick and place machine using image acquisition and display for setup.

FIG. 6 is an example screen image of the output display of the preferred embodiment of the invention.

FIG. 7 is a block diagram illustrative of the method of using a database to store placement information.

### DETAILED DESCRIPTION OF ILLUSTRATIVE EMBODIMENTS

In accordance with embodiments of the present invention, first article inspection is performed inside a pick and place machine. The operator of the machine is thus provided with real time feedback regarding problems occurring during the placement operation. Using this real time feedback, problems with the setup of the pick and place machine can be diagnosed and corrected quickly and before the whole board is completed, thereby reducing scrap rates.

Pick and place machine diagnostics are also aided in accordance with embodiments of the present invention. For example, problems are diagnosed rapidly by displaying errors directly to the operators during the placement to facilitate the correction of the problem before the problem produces unacceptable amounts of scrap. Also, by sharing placement information with other locations, both inside and outside the factory, even more expeditious diagnosis and problem resolution is possible.

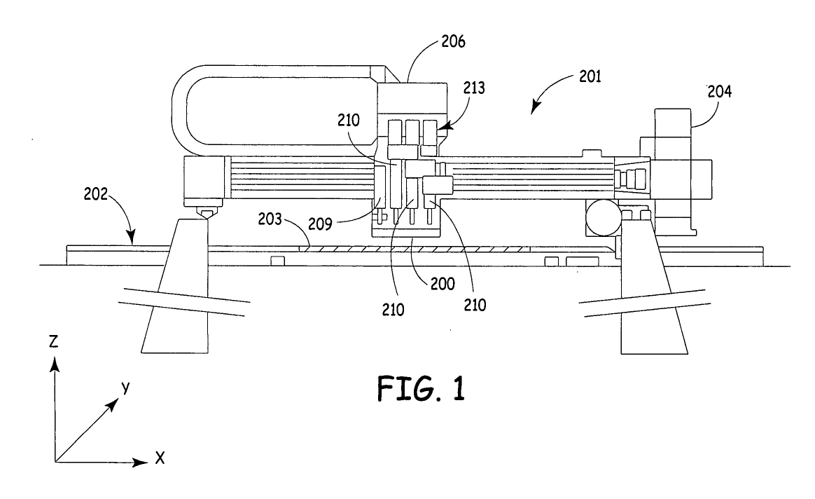

FIG. 1 is a diagrammatic view of an exemplary Cartesian pick and place machine 201 with which embodiments of the present invention are applicable. Pick and place machine 201 receives a workpiece, such as circuit board 203, via transport system or conveyor 202. A placement head 206 then obtains one or more electrical components to be mounted upon workpiece 203 from component feeders (not shown) and undergoes relative motion with respect to the workpiece in x, y and z directions to place the component in the proper orientation at the proper location upon workpiece 203. Placement head 206 may include an alignment sensor 200 that may pass under components held by nozzles 210 as placement head 206 moves the component(s) from pickup locations to placement locations. Sensor 200 allows placement machine 201 to view undersides of components held by nozzles 210 such that component orientation and, to some degree, component inspection can be effected while the component is being moved from the component pick-up location to the placement location. Other pick and place machines may employ a placement head that moves over a stationary camera to image the component. Placement head 206 may also include a downwardly-looking camera 209, which is generally used to locate fiducial marks upon workpiece 203 such that the relative location of placement head 206 with respect to workpiece 203 can be readily calculated.

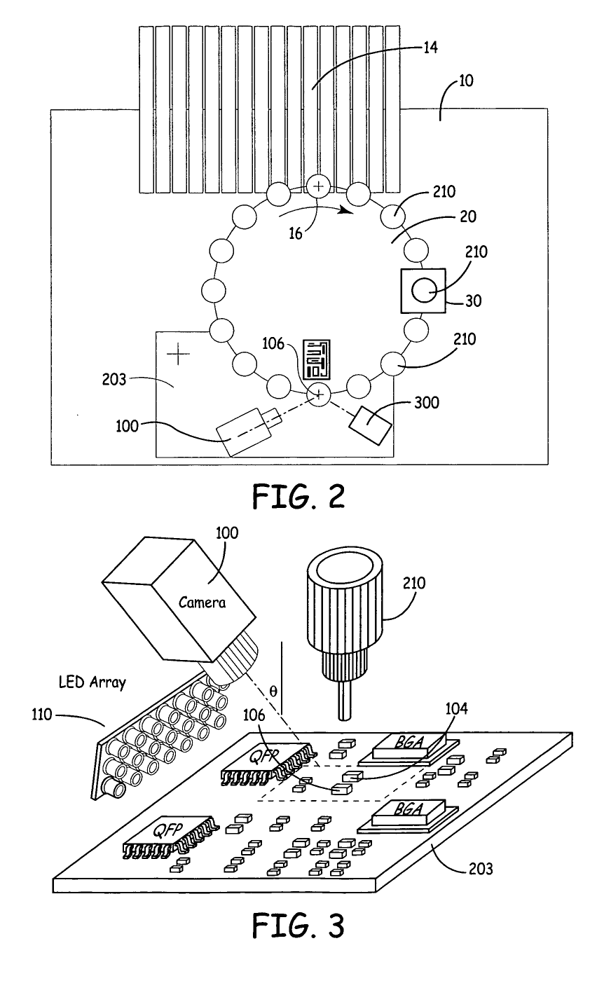

FIG. 2 is a diagrammatic view of an exemplary rotary turret pick and place machine 10 with which embodiments of the present invention are applicable. System 10 includes some components that are similar to machine 201 and like components are numbered similarly. For the turret pick and place machine 10, the workpiece 203 is loaded via a conveyor onto an x-y stage (not shown). Placement nozzles 210 are attached to main turret 20 and are disposed at regular angular intervals around the rotating turret. During each pick and placement cycle, the turret indexes an angular distance equal to the angular distance between adjacent placement nozzles 210. After the turret rotates into position and workpiece 203 is positioned by the x-y stage, a placement nozzle 210 obtains a component 104 from a component feeder 14 at a defined pick point 16. During this same interval, another nozzle 210 places a component 104 onto the workpiece 203 at a preprogrammed placement location 106. Additionally, while turret 20 pauses for the pick and place operation, an upward-looking camera 30 acquires and image of another component 104, which provides alignment information for that component. This alignment information is used by pick and place machine 10 to position workpiece 203 when the corresponding placement nozzle is positioned several steps later to place the component. After the pick and place cycle is complete, turret 20 indexes to the next angular position and workpiece 203 is repositioned in the x-y direction to move the placement location to a position that corresponds to the placement location 106.

During initial setup of the pick and place machine, many parameters and variables must be optimized and set correctly to ensure precise assembly of the workpiece. The following is a list of setup parameters that generally need to be determined:
Types of components;
Types of feeders required to handle the components;
Location of the feeders within the pick and place machine;
Sequence program containing the order and position of component placements;
Nozzle type required for each component;
Size and design of the workpiece;
Position and type of fiducials on the workpiece;
Speed of placement for each type of component;
Vacuum pressure for each type of component;
Vertical stroke of nozzle;
Placement and selection of board support pins;
Orientation of the board;
Vision parameters for component alignment;
Height of the component;
Height of the nozzle during pick and place operations; and
Lighting parameters for component alignment.

During the setup of the pick and place machine, an operator typically follows a procedure to load feeders into proper locations, load nozzles in a cassette, and assemble several workpieces using the appropriate placement program. After the first workpiece or group of workpieces is assembled, the operator inspects each workpiece using visual means or using an automatic optical inspection system. If an error is found, the cause of the error is investigated and corrective action is implemented. After the corrective action is implemented, another group of workpieces is assembled and inspected. This cycle of assembly, inspection and corrective actions is repeated until the operator determines the pick and place machine is ready for production.

FIG. 3 is a diagrammatic view of a placement head in accordance with embodiments of the present invention. FIG. 3 illustrates an image acquisition device 100 disposed to acquire images of placement location 106 of component 104 before and after the component 104 is deposited by nozzle 210 upon location 106. Device 100 obtains images of placement location 106 on workpiece 203 prior to placement of component 104 and then shortly thereafter. A comparison of these before and after images facilitates component-level placement inspection and verification. In addition, the area surrounding the component placement location 106 is also imaged. Since acquisition of images of the placement location is generally done when the nozzle, such as nozzle 210, holds the component 104 above the placement location, it is important to be able to image placement location 106 while minimizing or reducing interference from the component itself or adjacent components which may be already mounted upon the workpiece. Thus, it is preferred that the device 100 employ an optical axis allowing views that are inclined at an angle θ with respect to the plane of workpiece 203. An additional advantage of having the device 100 inclined at an angle θ is that vertical motion of the workpiece can be detected and measured by determining the translation of the workpiece between image acquisitions. It is also necessary to precisely time the image acquisition interval such that the workpiece 203 and the placement nozzle 210 are relatively aligned with each other and the component is high enough above workpiece 203 to visualize workpiece 203 from the camera angles. After component 104 is placed, the second image should be timed properly to acquire an image at a pre-selected time during the placement cycle. A method to precisely time the acquisitions of these two images is described in a co-pending patent application serial number 10/______, filed ______, and entitled Pick and Place Machine with Improved Component Placement Inspection. A method to detect vibration is described in co-pending U.S. patent application Ser. No. 10/_______, filed ______, entitled Pick and Place Machine with Workpiece Measurement.

Embodiments of the present invention generally obtain two or more successive images of the intended placement location (i.e. before placement and after). Since placement occurs relatively quickly, and since slowing machine throughput is extremely undesirable, it is sometimes necessary to acquire two successive images very quickly since cessation of the relative motion between the placement head and the board is fleeting. For example, it may be necessary to acquire two images within a period of approximately 10 milliseconds.

In accordance with various aspects of the present invention, rapid acquisition of multiple successive images can be done in different ways. One way is using commercially available CCD devices and operating them in a non-standard manner to acquire images at a rate faster than can be read from the device. Further details regarding this image acquisition technique can be found in U.S. Pat. No. 6,549,647, assigned to the Assignee of the present invention. Yet another way to rapidly acquire multiple successive images is to use multiple CCD arrays arranged to view the intended placement location through common optics.

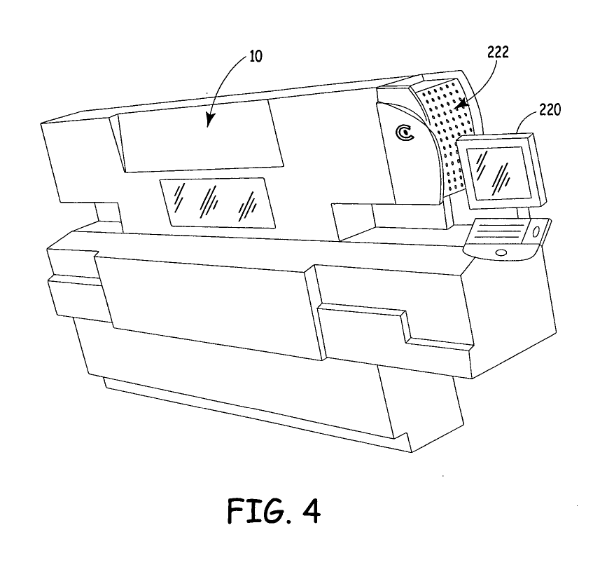

To be useful to the pick and place operator, images and data captured by the image acquisition device 100 requires a device to display the information. FIG. 4 shows one embodiment of this invention. For this embodiment of the invention, a processor 222 and a monitor 220 are mounted on pick and place machine 10. The location of the monitor 220 is chosen to provide the machine's operator with images and data gathered from the image acquisition system 100 shortly after the placement event. With images and data available to the operator during the assembly of the first board of a production run, the operator is able to make setup changes to the pick and place machine quicker than current practice.

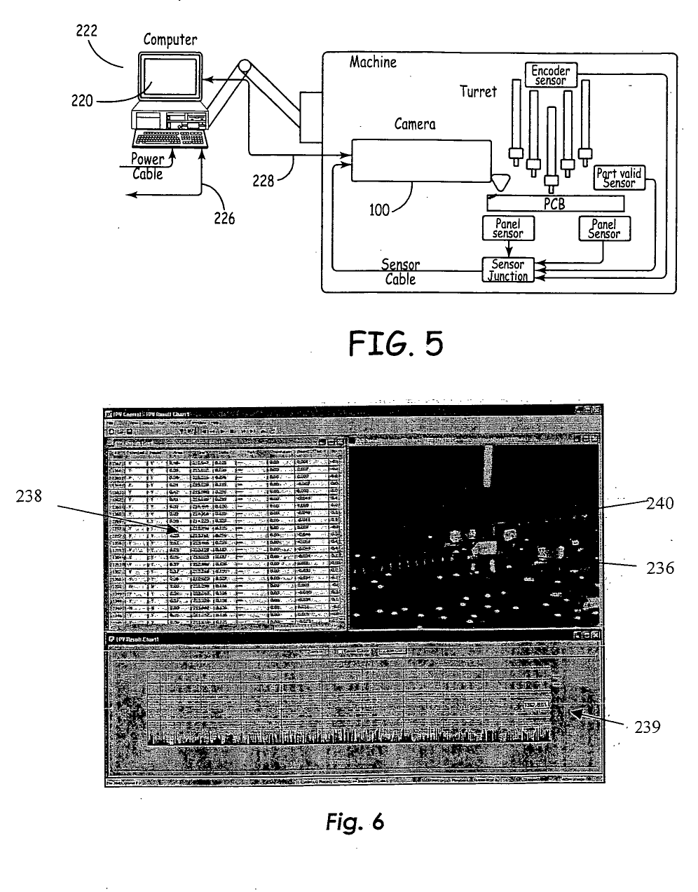

FIG. 5 is a block diagram illustrating operation in accordance with an embodiment of the present invention. Images acquired by the image acquisition system 100 are sent via a common video interface 228 to the processor 222. One such video interface is the IEEE 1394 standard commonly known as a Firewire camera interface. Processor 222 compares the before and after images to determine if the component was properly placed on the workpiece. Common defects that can be flagged are missed placements (no part placed), tombstoned or billboarded components where the component is tipped up on its end or side, misregistered placements, wrong part orientation, and excessive workpiece vibration. After the processing system 222 has completed its tasks, the results are displayed on monitor 220.

FIG. 6 is an example of the graphical output for this embodiment. Within the output, an image of placement site 240 is displayed. This image can be toggled between the before placement image, the after placement image and the difference image. Additionally, an indication of the quality of the placement 236 can be added to the image as graphical aide to the operator. The results of the image processing are displayed in tabular form 238 allowing the operator to quickly review the results of the current placements and a history of previous placements. A graphical display of the workpiece vibration 239 is shown in the lower portion of the screen. The vibration display can assist the operator by displaying the amount a workpiece vibration present as a function of placement sequence or, if placement location information is available to the image processor 222, a two-dimensional map of the board showing vibration as a function of board position can be displayed. Using this vibration information, an operator can quickly determine where additional board support pins are required to dampen vibrations in the workpiece.

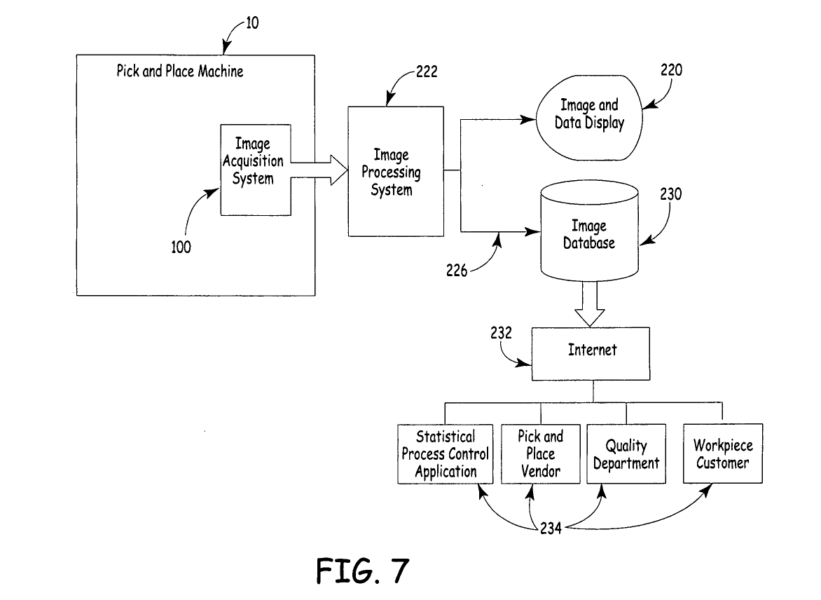

FIG. 7 is a diagrammatic view of a pick and place machine environment in accordance with an embodiment of the present invention. FIG. 7 illustrates a pick and place machine coupled to a database server 230. In this embodiment, images and data are displayed on monitor 220 as before and the images and data are additionally sent to a database server 230 via a common interface link 226 such as an Ethernet communication link. Once the images and placement data are stored on database server 230, the images and data can be queried and shared with other outside consumers 234 of the information. These consumers can include experts at the pick and place machine vendors facility, statistical process applications and the final buyer of the assembled workpiece. Since these consumers are not typically located in the factory with placement equipment, data and images can be retrieved from the data base server 230 using familiar Internet communications protocols 232.

Although the present invention has been described with reference to preferred embodiments, workers skilled in the art will recognize that changes may be made in form and detail without departing from the spirit and scope of the invention.

1. A pick and place machine for placing a component upon a workpiece, the machine comprising:
a placement head having at least one nozzle for releasably holding the component;
a robotic system for generating relative movement between the placement head and the workpiece;
an image acquisition device disposed to obtain at least one image of a placement location of a component;
an output display disposed near the pick and place machine;
wherein the at least one image of the placement operation is viewable to the machine operator using the output display.

2. A pick and place machine fault diagnosis system, the system comprising:
an imaging device for acquiring an image of the workpiece at an intended placement location;
an image processing system to process the image of the placement location;
an image display proximate to the pick and place machine; and
wherein the output of the image processing system is displayed on the image display shortly after the placement event before the assembly of the workpiece is complete.

3. The display system of claim 2 and further comprising:
a graphical display of workpiece vibration

4. The display system of claim 2 and further comprising:
a graphical display of an absence or presence of the placed component.

5. An machine fault diagnosis system for use in a pick and place machine, the device comprising:
an imaging device for acquiring an image of the workpiece at the intended placement location;
an imaging processing device to process the image of the placement location;
a database to store the image processing results of at least one characteristic of the placement operation; and
wherein fault diagnosis is based on results stored in the database.

6. A method of initial pick and place machine setup the method comprising of:
generating a placement event during which at least one component is placed onto a workpiece;
acquiring an image of the placement event;
displaying the image externally to a machine operator; and
adjusting at least one setup parameter of the pick and place machine based on the image.

7. The method of claim 6 and further comprising:
detecting absence of a component during the placement event; and
displaying an absence indication to the machine operator.

8. The method of claim 6 and further comprising:
detecting vibration of the workpiece during the placement event; and
displaying a vibration indication to the machine operator.

9. A method of diagnosing a fault in pick and place operation, the method comprising:
generating a placement event during which at least one component is placed onto a workpiece;
acquiring an image of the placement event;
storing the image of the placement event in a database; and
adjusting at least one parameter of the pick and place machine based on the stored image.

10. The method of claim 9 and further comprising:
extracting a placement parameter from the acquired image; and
storing the placement parameter in a database; and
adjusting at least one parameter of the pick and place machine based on the stored placement parameter.
